(19) United States
(12) Patent Application Publication
(10) Pub. No.: US 2022/0101680 A1
(43) Pub. Date: Mar. 31, 2022

(54) VENDING MACHINE FOR NATURAL FRUIT JUICES PREPARED ON THE SPOT

(71) Applicants: Eduardo Rodrigo GUTIERREZ SANCHEZ, Lima (PE); Liliana Antoinette ROMERO LOAYZA, Lima (PE); Azucena del Pilar GUTIERREZ SANCHEZ, Lima (PE)

(72) Inventors: Eduardo Rodrigo GUTIERREZ SANCHEZ, Lima (PE); Liliana Antoinette ROMERO LOAYZA, Lima (PE); Azucena del Pilar GUTIERREZ SANCHEZ, Lima (PE)

(21) Appl. No.: 17/298,691

(22) PCT Filed: Nov. 29, 2018
(86) PCT No.: PCT/PE2018/000032

§ 371 Date: Jun. 1, 2021

(51) Int. Cl. G07F 13/06; A47J 43/046; A47J 43/07; A47J 31/40; A47J 31/60; A47J 47/01; G07F 13/10

(52) U.S. Cl. CPC G07F 13/06; A47J 43/046; A47J 43/0716; A47J 2043/0733; A47J 31/60; A47J 47/01; G07F 13/10; A47J 31/40

(57) ABSTRACT

The present invention refers to a vending machine for juices made of natural fruit comprising a structure or framework, a module for storing and dispensing fruits having compartments for preserving fruit, helical bars for transportation disposed in each compartment which transport the pieces of fruit without damaging them, weighing hoppers that receive, measure and dose the weight of the pieces of fruit by means of load cells, a means for transferring the dosed fruit, a blending module with the upper part of the blender vessel modified to eliminate the need for closure or covering, modules for transporting liquids with peristaltic pumps and with tubular conduits to control accurately the amount of liquid supplied, a module for supplying food additives, a container dispenser, a module for the interaction between the user and the machine equipped with a touch-screen, a cooling module, a control module and preferably a modified module for drainage and safety.

### I. TECHNICAL FIELD

The present invention refers to a vending machine for beverages, more specifically to a vending machine for natural fruit juices prepared on the spot, with no use of preservatives, artificial products or flavorings; said fruit juices are made from natural fruit pulp and also by combining two or more fruits, that are previously peeled off and kept in pieces or cubes in refrigerated containers at low temperatures, to which water, ice, chia, quinoa are mainly added and optionally sugar, a sweetener or stevia; such juices can be dispensed in containers such as bottles or glasses.

### II. STATE OF THE ART

Vending machines for food products have been used for many years. Initially such vending machines used to have several parts and mechanisms that worked together in a synchronized manner; such vending machines were used to sell different products such as drinks, beverages, ready-to-eat foods, coffee, cigarettes, etc. One of such vending machines that contributed most for the sale of food products was the coffee vending machine, since it was among the first ones to mix components and include prior processes for the dispensing of a food product.

These technologies have been in the international market for over 100 years, its basic operation focuses on a structure that houses different modules (mechanical or electronic) which are synchronized as a set in order to supply the required product in accord with the amount of money inserted in the machine's slot. The latest developments in the manufacture of vending machines are focused on the interaction of the machine with the user, specifically with the help of electronics and software. It is quite recursive to find that in some developed countries like Japan, the United States, China, some vending machines have touch-screens and software for the recognition of recurring customers.

Current development is now directed to the customization of the required product by an individual user, so vending machines have been developed which have a user registration module using mobile applications, which allow that not only the preparation process in the vending machine to be quick, but also that such process be adjusted to the needs of each individual user.

Among the vending machines that are closest to this proposed invention, is patent U.S. Pat. No. 9,155,330B1, that refers to an automated vending machine to make beverages mixed with food products, such vending machines comprise a container to house a frozen or not frozen food product; a freezer system to control the temperature within the container, where the freezer system keeps the temperature below a freezing point; an ejection mechanism to expel the food product through its outlet, where the preferred ejection mechanism is a drill with a helical blade, which must be sufficiently sharp and strong in order to cut the pieces of food products that can be frozen together; an electric motor having a mechanic connection with the ejection mechanism, the operation of the electric motor causes the ejection mechanism to propel the food product into the container outlet; a control module in electric communication with the electric motor, this control module triggers the electric motor, causing the ejection mechanism to expel a preset amount of the frozen food product from the container that is controlled by means of a weight meter; a blender in electric communication with the control module, the blender has a rotating blade configured to pulverize the frozen food product; also, the blender has a mixing chamber configured to receive an ejected food product and a preset volume of a liquid, where the control module drives the blender to rotate the blade during a predetermined lapse to mix the frozen food product with the liquid to make a beverage; and a first electric valve in fluid communication with an interior space of the mixing chamber and in electric communication with the control module, so that the control module causes to open the first electric valve, dispensing the beverage from the mixing chamber to a container; the volume of liquid is controlled by the amount of pressure created by a pump located within the pipeline. However, this vending machine lacks an accurate control of the quantities or portions served, existing the possibility of dispensing a quantity different from what is required since it does not include a set of elements to deal with the technical problem of precision in dispensing the quantities or servings of the machine; therefore, said vending machine does not include peristaltic pumps to transport the fruit juice and other liquids from one place to another, where said pumps should not have contact with the liquids and so the flow pressure does not determine the amount of fluid that is required to be pumped; likewise, said vending machine does not include a high accuracy linear weighing module with weight meters of load cells capable of measuring precise and quickly the weight of each type of fruit, having constant communication with means of delivery of the frozen fruit, where said means of delivery do not break or deform the frozen pieces and allow to overcome the pressure on the frozen fruit pieces stored in containers; likewise, the scale requires independent motors for each type or channel of delivery of frozen pieces in order to achieve independent movements for the pieces, in accord with the selection of the type of fruit done by the user. Additionally, said vending machine does not include ways of reducing processing steps, shorten process times and save energy, for such purpose the present invention proposes a blender which has means for controlling the spill of the blended elements, letting the spilling occur only inside the vessel where said means for holding do not obstruct the entry of the elements to be blended. Said vending machine also does not include a mobile receiver responsible for the reception of containers, transporting and dispensing them to the user, that should be configured to move in three positions, each position having associated a defined task or function, said mobile receiver doing simple turning movements that save space, energy and time.

Another example of these vending machines related to the preparation of sodas is patent ES0469379 published on Feb. 1, 1979 fora “Soda Mixer” which describes an alternate machine for the preparation of sodas (carbonated beverages), where such vending machine can also mix ingredients, specifically the use of carbon dioxide, to aerate the beverage.

Another more recent example about vending machines that mix components to dispense a prepared beverage is patent GB2414015 published on Nov. 16, 2005 for an “Automated beverage dispenser” which describes a vending machine that can mix ingredients for the preparation of alcoholic and non-alcoholic beverages, such as cocktails, beverages with carbonated water, with flavorings, with ice, etc. Such vending machine includes several tanks, that hold the ingredients, and its ducts and pipelines that reach the specialized valves to place an ingredient in a container, such placement is made through a mechanism much like a roulette with accessories, each with a specific function, in such a way that when the “roulette” rotates on its axis it grants the adequate option to pour the ingredient as needed, such placement can be done in phases, by injection of carbonated water, etc. and then comes the stirring, that can be done with paddles, by oscillation around a vertical axis, and finally the mixture is poured in the container that will be removed by the customer. Such vending machine is ran by a computer, as a way to reach more efficiency and precision in the preparation of the beverages, and it uses a control panel to generate the order to prepare the beverage. It should be pointed out that such vending machine and its components secure the substantial reduction in wasting of ingredients, comply with food safety rules and is in keeping with the sanitary regulations.

Another previous instance is patent US20090067281 published on Mar. 12, 2009 regarding a “Cocktail maker” which describes a vending machine that mixes the ingredients by shaking a container in order to prepare cocktails, emulating the hand movements that a barman makes.

In another point of analysis of the state of the art, it is well known that beverage consumers are migrating from the consumption of artificial beverages with high sugar and preservatives content to natural beverages such as fruit juices; in this context, the juguerías, or shops that sell fruit juices and the like, play an important role, adopting various formats; in our country such diversity includes booths, kiosks or pushcarts, booths located inside neighborhood markets, up to shops in cafeteria or restaurant formats oriented to such purpose and also including the sale of other complementary products; lately, the use of small floor spaces for the mounting of shops of reduced size specialized in the preparation and sale of fruit juices, has spread; however, such small shops require an appropriate space of a minimum area size of 6 m² or more to operate normally. Such spaces are generally located in high traffic areas whose costs of leasing and implementation are high, such as shopping centers; on the other hand, areas with high human traffic have been identified, such as passenger stations, corporate or public offices, education centers, clinics, etc., said areas don't have the spaces needed to place a conventional juguería (including the ones with the reduced size format), but allow only the placement of vending machines of packaged food and beverages; this means that people cannot enjoy a natural fruit juice prepared on the spot, and is forced to consume substitute products such as sodas or other artificial beverages which are easily bought in traditional vending machines that due to the small area they need are usually located anywhere.

### III. DESCRIPTION OF THE INVENTION

Due to the deficiencies and limitations of the state of the art mentioned above, this invention provides a vending machine of fruit juices prepared on the spot and produced from refrigerated pieces of natural fruit, this vending machine integrates a set of essential characteristics hardly found in a similar juice vending machine; and which could not be even inferred from the combination of two or more of the above mentioned vending machines.

One of the most innovative elements of the present invention is a rotating mobile receiver which allows: i) to receive an empty container; ii) place the container on a small flat and split surface to avoid spillage; iii) turn it to fill the container with the prepared fruit juice; iv) turn it and go into dispatch position through the open space of the machine; v) to clean it up, in a closed location with no contact with the outside environment; vi) have a box for its isolation; vii) be removable; and, viii) receive wastewater from the second outlet con du it of the blending vessel and lead it to the drain.

Furthermore, the present invention includes a modified blender with a vessel with inlet and outlet openings for liquids and food additives, a cone-shaped blending mix protector with support arms placed on the top of the vessel, a blender lid located above the blending mix protector, which is an extension of the upper edge of the vessel that gradually reduces the total opening of the blender vessel, said lid can be part of the vessel or be a removable element; the blending mix protector and blender lid work together to prevent the blended items from spilling or splashing, without obstructing the entry of frozen pieces of fruit, food additives, or water, and without the need for opening or closing the blender vessel, which helps to save time in the blending process, saves energy by reducing the steps for blending, among other advantages that will be detailed in later chapters.

In general, the mobile receiver and the modified blender enable the reduction of stages of the juice preparation process in a vending machine, reduce processing times and save energy.

In order to achieve precision in the measurement of the quantities being served, the present invention includes a lineal weigher with at least four distribution channels and four hoppers (buckets) with a weighing system by means of load cells to which helical bars have been adapted in each distribution channel and an independent movement of the means of distribution has been configured for it. Different types of dispensing such as vibration systems, belts, spiral wires and helical bars (endless screw) have been tested, finding out that only the helical bars do not break or crack the pieces of fruit as they are displaced. The linear weigher with weighing system of load cells and with helical bars provides an accurate measurement of the quantity of frozen fruit pieces to be dispensed, which is extremely important for standardizing the flavor and quantity of products to be mixed into the final product to be delivered to the user and allows to achieve efficiency in the use of ingredients and costs. These load cells operate under torque and are capable of withstanding very low temperatures.

Another advantage related to the accuracy in quantity measurement is that peristaltic pumps are used which will allow more precise control of the amount of fluids (regardless of pressure), better control of the volume dispensed in the container or bottle, and also to expel the washing water in a safe way since it is very difficult for the washing water to slide back with this type of pump; likewise, the pumping through peristaltic pumps does not have contact with the liquid, thus reducing the possibility of its contamination.

In addition, the present invention includes a sanitary security barrier that prevents the proliferation of microorganisms, the passage of insects or animals, and odors from the sewer.

This invention has a suitable design for its purpose, with high automation, a low manufacture cost and is of easy handling or use, more advantages or characteristics of this invention will be detailed further below.

### A SHORT DESCRIPTION OF THE FIGURES

The attached figures represent a preferred embodiment of the present invention and are not intended to limit in anyway the scope of protection of the claims, said figures are shown fora purely illustrative and guiding purpose for carrying out the invention.

FIG. 1: Isometric view of the vending machine;

FIG. 2: Front view the vending machine;

FIG. 3: Front view of the storage and dispensing module;

FIG. 4: Isometric view of the storage and dispensing module;

FIG. 5: Isometric view of the right rear side of the storage and dispensing module;

FIG. 6: Top view of the storage and dispensing module;

FIG. 7: View of the fruit dispensing sub-module;

FIG. 8: Inside view of the fruit storage sub-module (compartments);

FIG. 9: Hopper.

FIG. 10: Helical bar

FIG. 11: Blender

FIG. 12: Blender vessel

FIG. 13: Base of the blender

FIG. 14: Blender lid

FIG. 15: Blending mix protector

FIG. 16: Mobile receiver

FIG. 17: Top view of the mobile receiver in position A (with the front on the machine by the bottom side of the figure).

FIG. 18: Top view of the mobile receiver in position B (with the front on the machine by the bottom side of the figure).

FIG. 19: Top view of the mobile receiver in position C (with the front on the machine by the bottom side of the figure).

FIG. 20: Isometric view of the box containing the mobile receiver.

FIG. 21: Top view of the box containing the mobile receiver.

FIG. 22: Isometric view of the dispensing module FIG. 23: Front view of the dispensing module.

FIG. 24: Peristaltic pump.

FIG. 25: Containers of the food additive supply module

FIG. 26: Drainage module or sanitary security module

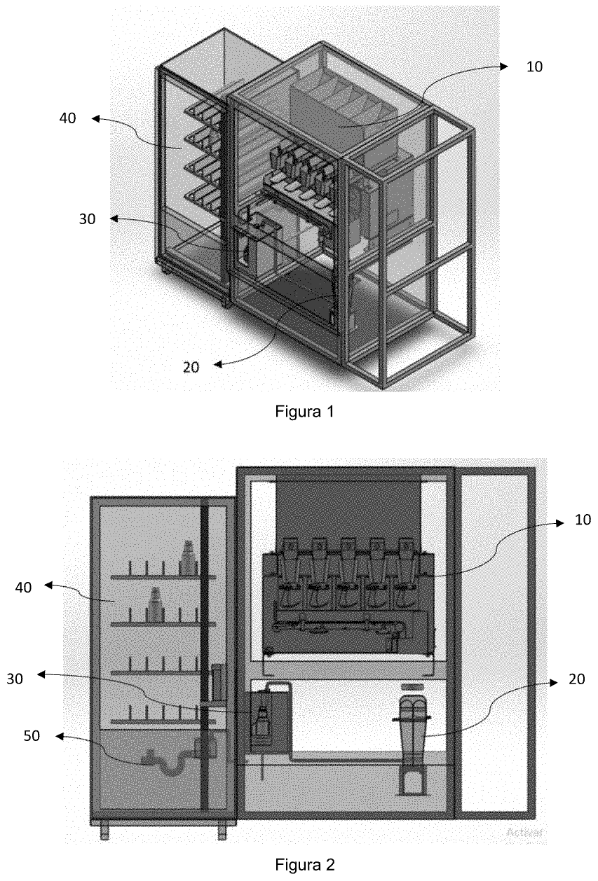

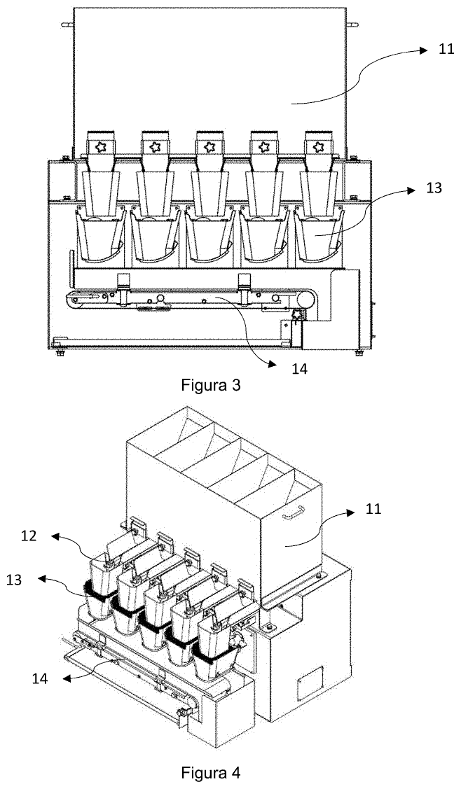

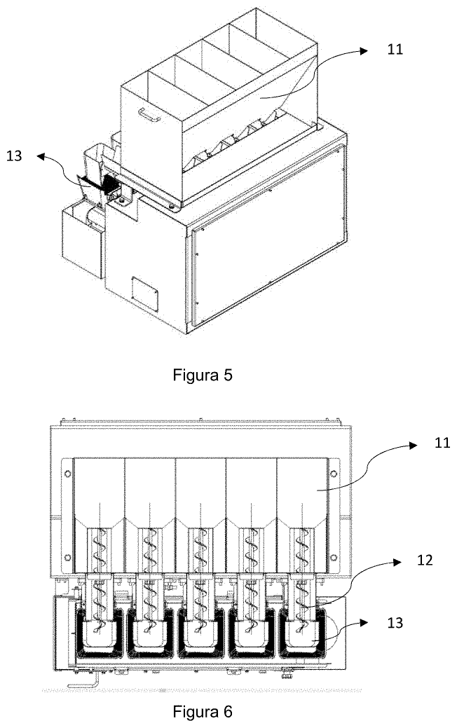

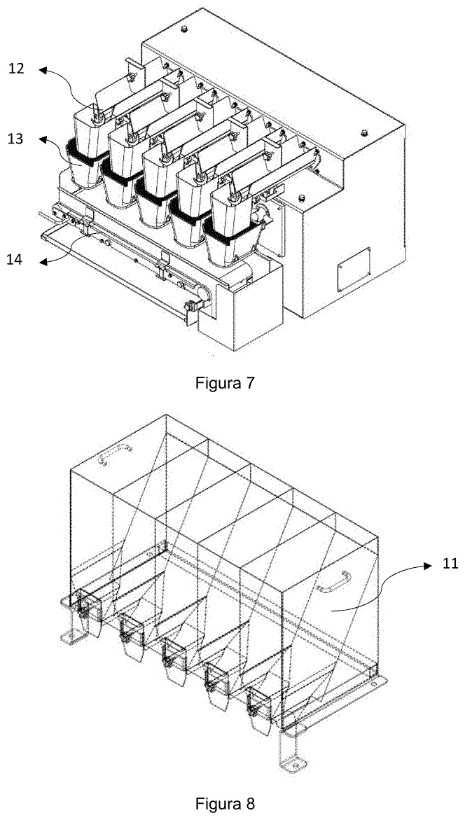

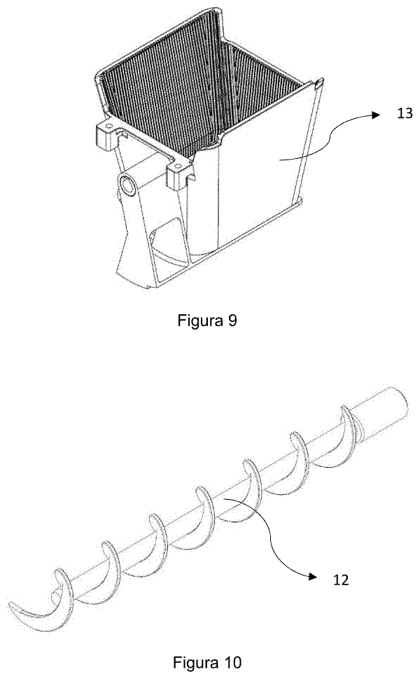

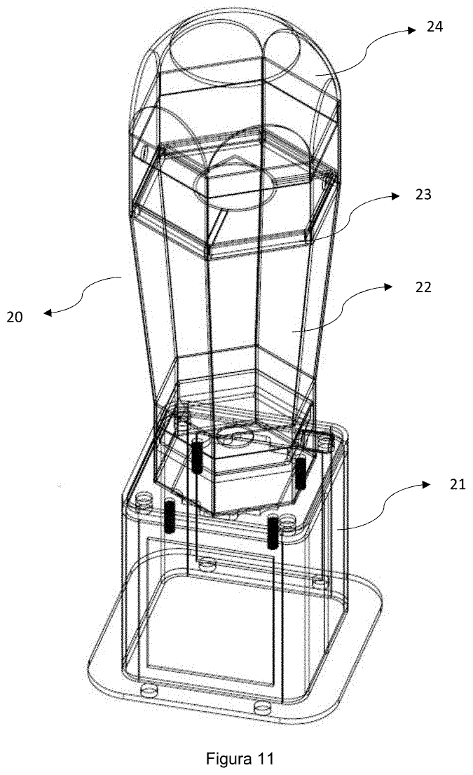

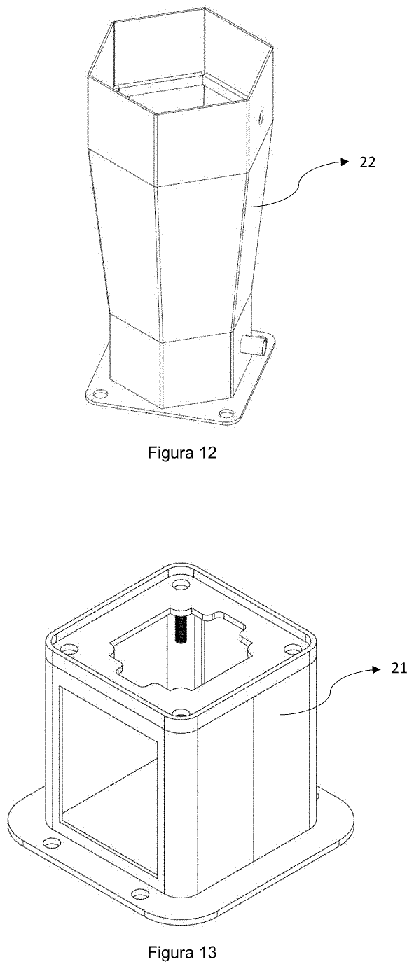

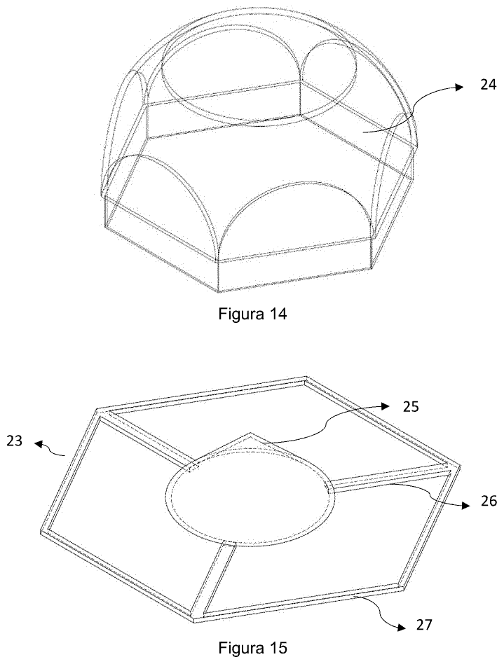

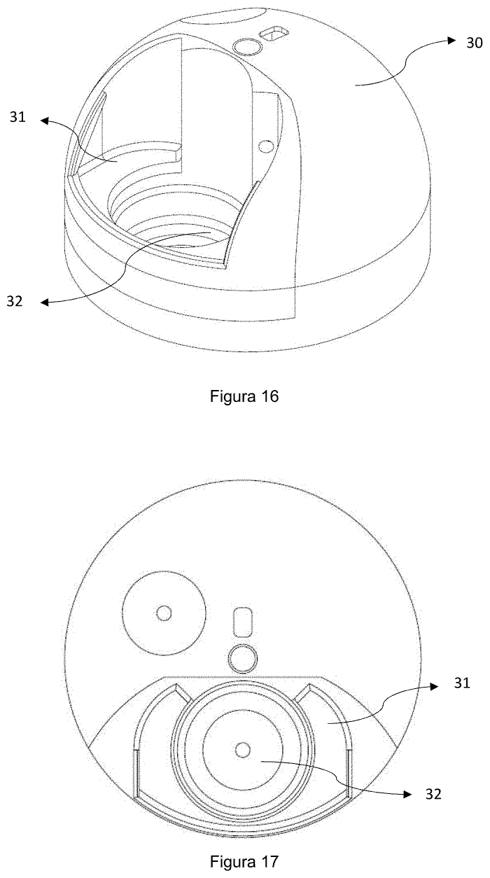

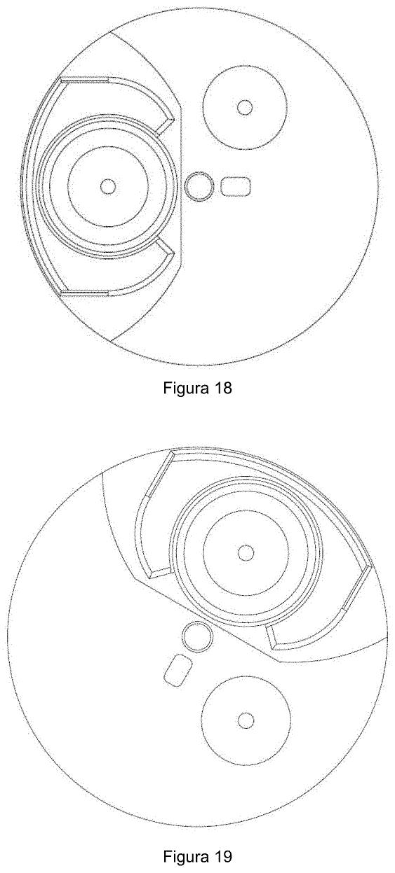

### DETAILED DESCRIPTION OF THE INVENTION AND PREFERRED FORMS OF EMBODIMENT

In order to natural fruit juices prepared on the spot, the present vending machine has the following components:
a) A control module,
b) An user-machine interaction interface,
c) A fruit storage and dispensing module (10),
d) A container dispenser,
e) A water supply module,
f) A food additive supply module,
g) A blending module,
h) Mobile receiver (30),
i) A cooling module,
j) A drainage module or sanitary security module (50),

a) Control module.

The control module that encloses the power supply devices and comprises electrical circuits resistant to temperatures from 5° C. for the area with out freezing and other circuits capable of withstanding temperatures from −25° C. for the freezing area. The control module uses an algorithm that guarantees safe operation and, in the event of failures, performs an emergency operation which consists of stopping a sub-process and restarting it; or stop the whole process and try to restart or stop the vending machine to avoid bad service. It also includes controllers that perform a specific task of the module to facilitate fault detection and to be able to change and modify sub-modules in the future. This module receives information from the user-machine interaction interface, and controls the fruit storage and dispensing module (10), the blending module, the water supply and food additive modules, the container dispenser and the mobile receiver (30).

b) User-machine interaction interface.

The user-machine interaction interface is placed on the front of the structure and has a touch-screen that communicates serially with the controller of the control module. Additionally, this interaction module has a platform that allows the user to select the fruits to be mixed in the juice, the platform is governed by the following processes:
It begins with a loop of product advertising or other necessary advertising.
After the screen is touched, the fruit selection menu and the selection of food additives (chia, quinoa, sugar, sweetener or stevia) appear, and as the products are selected, a nutritional description of each chosen fruit is displayed on the screen and so are the price and the button to accept the order.
When accepting the order, the order and its price are shown and the payment is requested, once the payment is made, the start button appears.
By pressing the start button, the coded signal with the order are sent to the controller of the control module and immediately the juice preparation starts.

c) Fruit storage and dispensing module (10).

This module includes a container (11) divided into at least four compartments to store at least 4 different types of fruit, preferably each compartment has a volumetric capacity of at least 16 liters, for each compartment there is a helical transport bar (12) with a coupled electric motor that allows the bar to rotate and independently move the frozen fruit pieces from the compartments towards a linear weigher with at least four hoppers (13) (buckets) with an independent weighing system by means of load cells, said load cells enable to measure and dose the pieces of fruit accurately. Once the dose of fruits has been measured, they are directed towards a means of transfer for the dosed fruit (14) which can be a conveyor belt, which will finally carry the dosed fruits towards the blending module, said means of transfer for dosed fruit (14) is located under the hoppers (13). In a preferred embodiment, a funnel is placed between the means of transfer for the dosed fruit and the blending module.

The linear weigher with a weighing system by means of load cells with the helical transport bars (12) provide a very accurate measurement of the quantity of pieces of frozen fruit to be dispensed, which is extremely important for standardizing the flavor and quantity of products to be mixed in the final product to be delivered to the user and enables to achieve greater efficiency in the use of ingredients and costs. Such load cells operate under torque and are capable of withstanding very low temperatures.

In general, this module is preferably equipped with food grade stain less steel and has a low temperature resistant circuit withstanding temperatures from −25° C.

d) Container dispenser.

For the design of the empty container dispenser to be used for prepared fruit juice, a beverage dispenser of the XY type was taken as the basis, that is, this module includes an empty container receptacle (40) and a means of transport for the empty containers (41) communicated to the order and needs of the control module, once the signal is received from the control module it will move and take the empty container, the dispensing will preferably be in order from left to right and bottom to top, continuing with the process the container will be taken to the exit point or position where it will place the empty container in a mobile receiver (30) and will move to the initial position where it will wait for the next order.

e) Water supply module.

The water supply module preferably includes a peristaltic pump (60) with conduits that communicate a water supply source with the blending module and, at least one water supply valve to control with accuracy the quantity of water supplied. In a preferred embodiment, the water supply module includes a high quality purifier that uses UV rays for the sterilization process, the water supply source can be a storage tank of preferably one liter volumetric capacity or a connection with water from public services in order to always have the amount of water needed immediately.

This module is also in charge of supplying water for cleaning up the blender (20), the tubular conduits, the mobile receiver (30) and preferably the means of transport for the dosed fruit (14).

f) Food additive supply module.

The food additive supply module is located above the blending module and includes containers (70) to hold additives, at least one valve for each container (70), and conduits that communicate the container valve with the blender (20) in order to transport the additives by gravity. In a preferred embodiment, the food additive supply module involves four containers (70) for holding additives for the juices such as stevia, chia, etc. This module is removable, the design of which was made taking into account the ease of cleaning and maintenance of the machine. For the present invention, chia, quinoa, sugar, sweetener, stevia, or any other solid granulated aggregate will be considered as food additives.

g) Blending Module

This module comprises a blender (20) which in turn includes a vessel (22), a base (21), a blender lid (24) and a protector of the blending mix (23); the blender vessel (22) has at least one lateral inlet hole for a conduit through which the purified water flows, such purified water can be used to prepare the juice or for the cleaning process. The blender vessel also has at least one outlet hole at the bottom that will allow it to drain or serve the prepared fruit juice. The protector of the blending mix (23) has the shape of a cone (25) which is supported by at least two arms (26), and where said arms extend until they are connected with a structure that takes the shape of the upper edge or mouth (27) of the blender vessel, said cone (25) is located concentrically with the projection of the axis of rotation of the blender, in its upper part, and fulfills the function of avoiding the splashing of the juice when blending the fruit, but it lets, at the same time, the free passage of the pieces of fruit towards the vessel. The blender lid (24) is an extension of the upper edge of the blender, has a hole in its center, where said lid extends towards the central axis of rotation, forming a reduced opening in the upper part of the vessel to eliminate the need for closing it, this lid (24) is located in a higher position than the protector of the blending mix (23) and works as a second barrier for the leakage of the juice at the time of blending, through the areas where the protector of the blending mix (23) does not reach. Said lid (24) may be part of the blender vessel (22) as a single unit or be arranged to be removable. In this way, in a joint action of the protector of the blending mix (23) and the blender lid (24) prevents the splashing of the juice at the time of blending and also allow the entry of the pieces of fruit with no need for opening and closing the blender vessel. The blender vessel (22) has an outlet conduit communicated with a mobile receiver (30).

In a preferred embodiment, a peristaltic pump (60) connected with the outlet conduit communicates the blender (22) with a container in the mobile receiver (30), the peristaltic pump (60) will guarantee that the volume of juice does not overflow the container since the peristaltic pump (60) performs a very precise control of its volume and, in addition, note that this type of pump does not have contact with the working fluid, guaranteeing the good health of the product. The blender (22) is specially conditioned to receive pieces of fruit, it is also conditioned to facilitate the connections of tubular conduits where the water will enter and also the juice and the rinsing waters of the vessel will go out, it should also be noted that the blender (22) is modular (removable coupling) to facilitate the movement of certain components du ring its maintenance, the module has a motor whose power and operating time have been calculated and previously analyzed, in a preferred embodiment, the blender base (21) is fixed to the vending machine structure to reduce module vibrations.

The blending process is carried out as follows:
The entry of frozen fruit pieces and natural additives is made through the upper entrance of the blender.
The entrance of the purified water is made through at least one hole in the upper side area of the vessel.
The fruit juice is blended.
The vessel is drained and the juice is poured into the container (preferably a bottle).
Cleaning up begins with the entry of purified water and then the blending action begins only with the purified water, which cleans the vessel and the outlet ducts, this process is carried out two times to ensure the cleanliness of the vessel.

h) Mobile receiver (30).

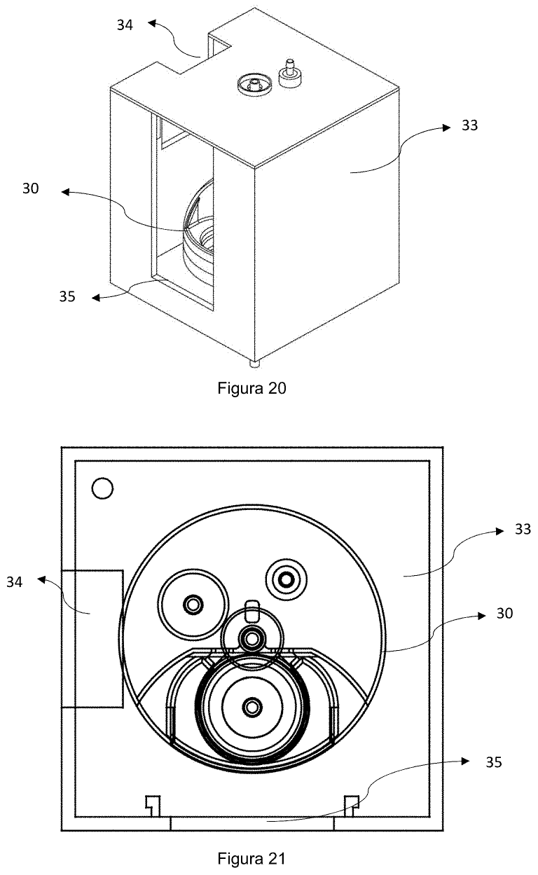

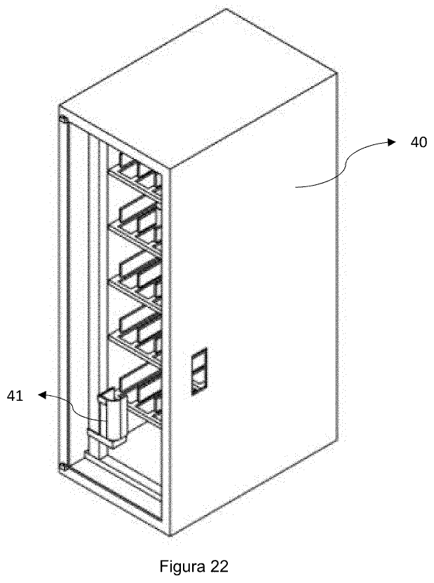

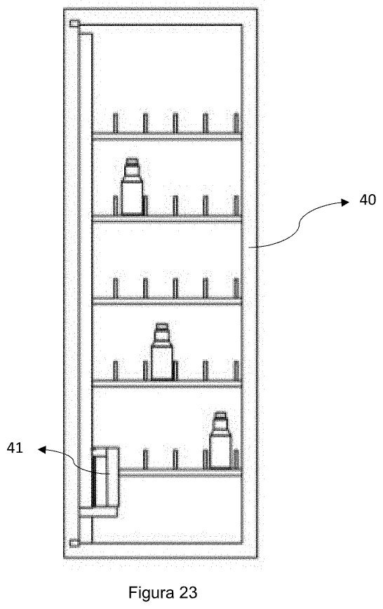

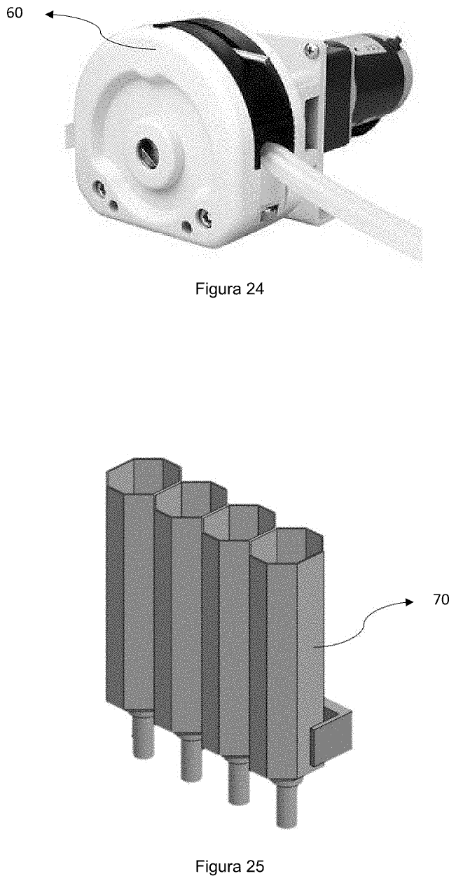

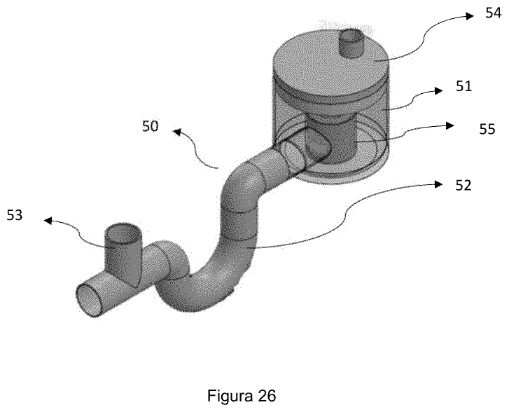

Another innovation proposed in the present invention is a mobile receiver (30) that is responsible for the reception of containers, transporting and dispensing them to the user, said mobile receiver is configured to move, by rotation, in three positions, each position has an associated task or defined function: position A (as shown in FIG. 17 from a top and front view of the machine), position B (FIG. 18) and position C (FIG. 19); each position will be explained in detail below:
Position A is located in a space open to the public and allows the container with the prepared juice to be removed by the user.
Position B is the default position that is ready to receive empty containers that arrive from the container dispenser, in this position the cleaning process also occurs.
Position C is where the container is filled with the prepared fruit juice.

Next, the work sequence of the mobile receiver (30) for an order will be described:
By default the receiver is in position B, once the process has started the mobile receiver (30) will remain in position B until the empty container is dropped or is received from the container dispenser.
Once the mobile receiver (30) has the empty container, it rotates (preferably clockwise) towards position C where it will be filled up with fruit juice, preferably 450 ml of fruit juice.
After completing the filling up, it rotates (preferably in an anti-clockwise direction) until it reaches position A where it will wait until the container is removed by the user.
After a few seconds (between 2 and 5 seconds) that the filled container is removed, the mobile receiver (30) will rotate (preferably clockwise) to position B where it will start the cleaning process.
Finally, the mobile receiver (30) will remain in said position until the next command.

This mobile receiver (30) has a rotary movement and has a circular structure that preferably has the shape of a dome or semi-sphere and which includes a first flat section (31) (and split in case of being a semi-sphere) to receive a container, in its central part a second flat and slit section (32) is established, which is circular to support the base of the container and prevent its fall due to rotational movement or a slight and involuntary side movements of the container. Preferably, the first flat section (31) of the mobile receiver includes at least one hole through which at least one hose with a washing liquid is entered and allows cleaning it up of any dirt or spillage. Likewise, this mobile receiver comprises a central axis of rotation and preferably a hole located on the side of the central axis of rotation to insert electrical connection cables and/or hoses with the cleaning fluid. In another preferred form, the mobile receiver is contained within a box (33) fixed to the structure of the dispensing machine, where said box has a first opening (34) through which empty containers are received and a second opening (35) where the prepared beverage is removed. The section of the dome of the mobile receiver, which is not split, obstructs the opening of the structure where the beverage is removed when it is in positions B and C, and allows the removing of the beverage through the opening when it is in position A.

This mobile receiver (30) is unique in its kind, it provides simple rotational movements for immediate dispensing, consuming a minimum electrical power with said rotational movements to receive the empty container, the filling and the dispensing to the user, while keeping the container in isolation to ward it from polluting agents from the outside environment until its final dispensing in position A; while having the second flat and split section (32) as support for the container to prevent the juice from splashing or spilling.

Likewise, this mobile receiver (30) includes a third outlet tubular conduit that derives the liquids it receives from the second outlet tubular conduit of the blending module and directs them to the drain or, in a preferred embodiment, to the drainage module proposed in the present invention.

In a preferred embodiment, the mobile receiver (30) includes a funnel and a container to momentarily receive the washing liquids from the blending module and divert them to the drain through the third outlet tubular conduit and another peristaltic pump (60).

i) Cooling module.

The main function of this module is to keep the fruit preservative compartments refrigerated, for this purpose the module consists of a cold chamber with preferably two refrigeration areas or zones, the first one destined for the fruit preservative compartments, is kept at a temperature between −25° C. and −15° C. to keep the pieces of fruit in good condition; the second one is the lower area of the structure that is maintained at a temperature between 3° C. and 10° C., the main function of this area is to keep the environment at a cold temperature for safety. The refrigeration system can reach freezing temperatures or can be operated above freezing. This module is located inside the structure of the vending machine

j) A drainage module or sanitary safety module (50).

The present invention may comprise in a further embodiment this module. This module consists of an odor trap (52), an aeration valve (53) and a siphon tank (51), where the siphon tank (51) preferably has a cover (54) that serves as a connection with the conduits coming from the internal washing. In this sense, the con du its to evacuate the washing residues are connected to the modified siphon tank (51) at the top since its function is not to collect gray water, but rather, it serves to create a harmful environment for many insects, to that effect, the inlet of the siphon tank is placed on its lid (54) (upper part of the tank) and inside the siphon tank (51) there will be some bactericidal and insecticidal crystals that will eliminate any sign of proliferation of bacteria and insects this further isolates the drain from the blending machine (conventional siphon tanks have its inlets on the lower side, which does not help to create an area such as that required for the present invention). Additionally, inside the siphon tank (51) an anti-odor valve (55) is placed that communicates with the outlet of the siphon tank (51), the anti-odor valve (55) by default is closed, it only opens when there is fluid passage in the tank, an element that gives extra protection. The odor trap (52) consists of a “U” shaped tube that connects to the outlet of the siphon tank, and an upper hole at the end of the tube to place an aeration valve (53) which serves to protect the drainage from pressure changes in the surroundings. The aeration valve (53) is a way of protecting the area outside the module (mainly sewers), where abrupt pressure changes can arise that cause the odor trap elbow (52) not to work correctly and finally in the outlet to the sewer is preferably to have a grid with enough space between the slits so that the washing water comes out with some type of remains of the juice that has been left in the blender (22) after its use. The siphon tank (51), the odor trap (52) and the aeration valve (53) are connected in series.

As mentioned above, the means of transport for the dosed fruit (14) from the hoppers (13) or buckets to the blender (20) can be a belt or conveyor belt, the transport of the liquids will be carried out through peristaltic pumps (60), the transport of the solid food additives will be by gravity through ducts and the transport of the frozen fruit cubes from the compartments to the hoppers or buckets will be carried out in a gradual manner through the helical bars (12) and independent electric motors.

Additionally, the aforementioned modules and components are contained within a structure of the vending machine.

The general process of the present invention is carried out as follows:
1. It starts with the manipulation of the user-machine interaction module, where the user will choose the fruits and food additives that are going to be mixed or added in his fruit juice; after the selection and the corresponding payment, the interface will code the order and will send it to the control module.
2. Once the information reaches the control module, it immediately begins to decode the information and starts the order preparation operations.
3. The order preparation operation consists of four tasks that are done simultaneously, they are: the dispensing of the empty container to the mobile receiver (30), the dispensing of the fruits that are weighed and transported to the blending module, the dispensing of food additives and the supply of water for fruit juice preparation.
4. Once the control module verifies that the four previous tasks have been completed, it sends the order to begin blending.
5. The blending is continued for an approximate time of preferably 20 seconds, the dosage begins to the container placed in the mobile receiver (30) in position C and finally the mobile receiver rotates to position A for dispatching to the user.
6. After finishing the dispensing of the fruit juice, the cleaning process begins, which takes about 30 seconds.
7. Once the cleaning up is finished, the control module will send an end-of-process signal to the platform module to show the readiness for starting a new cycle.

1-5. (canceled)

6. A vending machine for natural fruit juices prepared on the spot, comprising:
a fruit storage and dispensing module which consists of a container divided into at least four compartments, for each compartment there is a helical transport bar with a coupled electric motor that rotates the bar and moves pieces of frozen fruit from the compartments to a linear weigher; said linear weigher has at least four hoppers with an independent weighing system that uses load cells, said load cells allow the fruit pieces to be measured and dosed accurately, a transport means under the hoppers transfers the dosed fruit into a blending module;
the blender module includes a blender, which comprises a base, a vessel, a blending mix protector and a blender lid; the blending mix protector has the shape of a cone which is supported by at least two arms, and where said arms are connected with a structure that takes the shape of the upper edge or mouth of the blender vessel, said cone is arranged concentrically with the projection of the axis of rotation of the blender, in its upper part, the blender lid becomes an extension of the upper edge of the blender and has a hole in its center, where said lid extends towards the central axis of rotation, forming a reduced opening in the upper part of the vessel; the blending mix protector and the blender lid work together to prevent the blended items from splashing or spilling without obstructing the entry of the frozen fruit pieces; the blender vessel has a first tubular outlet conduit in communication with a mobile receiver;
a water supply module that consists of a water supply source with at least one valve and a second tubular conduit that communicates this module with the blending module;
a food additive supply module located above the blending module comprising containers for holding additives, and ducts that communicate said containers with the blender to transport the additives;
a container dispenser which consists of a container receptacle and a container transport means for moving the containers from the container receptacle towards the mobile receiver;
the mobile receiver which consists of a circular structure with rotary movement that has the shape of a dome or semi-sphere and which in turn comprises a first flat and split section, where a second flat split section is set which is circular in order to support the base of a container and prevent its fall due to rotational movement or a slight and involuntary side movements of the container; and a third tubular outlet duct of the mobile receiver that diverts the liquids it receives towards the drain;
a user-machine interaction interface located in the front part of the structure provided with a touch-screen, where the fruits and food additives to be mixed are selected;
a cooling module connected with the compartments of the fruit storage and dispensing module, and located within the structure of the vending machine;
a control module that has power supply devices and controllers, which receives information from the user-machine interaction module, connects and controls: the fruit storage and dispensing module, the blending module, the water supply and food additive modules, the container dispensing module, and mobile receiver;
a drainage module or sanitary security module that consists of a siphon tank, an odor trap and a series connected aeration valve; wherein the siphon tank that consists of a lid, an inlet in said lid that receives the washing liquids, an anti-odor valve located inside the tank that communicates with an outlet of said siphon tank; and
a structure containing the aforementioned modules and components of the vending machine.

7. The vending machine for natural fruit juices prepared on the spot according to claim 6, wherein the first tubular duct of the water supply module and the second tubular outlet duct from the vessel of the blending module consists of some peristaltic pumps.

8. The vending machine for natural fruit juices prepared on the spot according to claim 6, wherein the base of the blender is fixed to the structure of the vending machine.

9. The vending machine for natural fruit juices prepared on the spot according to claim 6, further comprising a funnel is placed between the transport means of the fruit storage and dispensing module and the blending module.

10. The vending machine of natural fruit juices prepared on the spot according to claim 6, wherein the mobile receiver is placed inside a box that consists of a first opening through which the empty containers are received and a second opening through which the prepared beverage is removed.
